(19) United States
(12) Patent Application Publication
(10) Pub. No.: US 2010/0183495 A1
(43) Pub. Date: Jul. 22, 2010

(54) PROCESS FOR PREPARING HIGH-PURITY SILICON DIOXIDE GRANULE

(75) Inventors: Kai Schumacher, Hofheim (DE); Christian Schulze-Isfort, Limeshain (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/667,796

(22) PCT Filed: Jun. 16, 2008
(86) PCT No.: PCT/EP2008/057568

§ 371 Date: Jan. 5, 2010

(30) Foreign Application Priority Data
Jul. 6, 2007 (DE) 10 2007 031 633.1

(51) Int. Cl. C01B 33/12

(52) U.S. Cl. 423/335

(57) ABSTRACT

Process for preparing a silicon dioxide granule having a specific surface area of less than 1 m²/g and a proportion of impurities of less than 50 ppm, in which a) a silicon dioxide powder with a tamped density of 15 to 190 g/l, b) is compacted to slugs which are subsequently crushed, the slug fragments having a tamped density of 210 to 800 g/l, and c) the slug fragments are treated with one or more reactive compounds at 400 to 1100° C.

The invention relates to a process for preparing a high-purity silicon dioxide granule, and to the granule itself.

Numerous methods are known for preparing granules proceeding from amorphous silicon dioxide. Suitable starting materials may be silicon dioxide prepared by sol-gel processes, precipitated silica or a pyrogenic silicon dioxide. The preparation usually includes an agglomeration of the silicon dioxide. This can be done by means of wet granulation. In wet granulation, a sol and, from this, with gradual removal of the moisture, a crumbly material are obtained from a colloidal silicon dioxide dispersion by constant mixing or stirring. Preparation by means of wet granulation is complicated and costly, especially when high demands are made on low contamination of the granule.

It is also possible to obtain granules by compacting silicon dioxide. The compaction, without binder, of pyrogenic silicon dioxide is difficult because pyrogenic silicon dioxide is very dry, and no capillary forces can bring about the particle binding. Pyrogenic silicon dioxides are notable for extreme fineness, a low bulk density, high specific surface area, very high purity, very substantially spherical primary particle shape and the absence of pores. The pyrogenic silicon dioxide frequently has a high surface charge which complicates the agglomeration in electrostatic terms.

The compaction of pyrogenic silicon dioxide has to date not constituted a usable route to the preparation of high-value granules.

U.S. Pat. No. 4,042,361 discloses a process for preparing silica glass, in which pyrogenic silicon dioxide is used. It is incorporated into water to form a castable dispersion, then the water is removed thermally, and the residue in piece form is calcined at 1150 to 1500° C. and then ground into granules of 1-100 μm in size and vitrified. The purity of the silica glass thus prepared is insufficient for current applications. The preparation process is complicated and costly.

WO 91/13040 also discloses a process in which pyrogenic silicon dioxide is used to prepare silica glass. The process comprises the provision of an aqueous dispersion of pyrogenic silicon dioxide with a solids content of about 5 to about 55% by weight; the conversion of the aqueous dispersion to porous particles by drying the aqueous solution in an oven at a temperature between about 100 and about 200° C., and comminuting the dried porous particles; and subsequently sintering the porous particles in an atmosphere with a partial water pressure in the range of 0.2 to 0.8 atmosphere at temperatures below about 1200° C. High-purity silica glass granules are obtained with a diameter of about 3 to 1000 μm, a nitrogen BET surface area of less than about 1 m²/g and a total impurity content of less than about 50 ppm and a content of metal impurity of less than 15 ppm.

EP-A-1717202 discloses a process for preparing silica glass granule by sintering a pyrogenic silicon dioxide which has been compacted to tamped densities of 150 to 800 g/l by a particular process. This process, disclosed in DE-A-19601415, involves a spray-drying of silicon dioxide dispersed in water and subsequent heat treatment at 150 to 1100° C. The granule thus obtained can be sintered but does not afford bubble-free silica glass granules.

EP-A-1258456 discloses a process for preparing a monolithic shaped glass body, in which a silicon alkoxide is hydrolysed and then a pyrogenic silicon dioxide powder is added to form a sol, the sol is subsequently converted to a gel, and the gel is dried and then sintered.

EP-A-1283195 likewise discloses sol-gel processes in which silicon alkoxides and pyrogenic silicon dioxide powders are used.

DE-A-3535388 discloses a process for preparing doped silica glass in which an ultrafine silicon dioxide particle is added to a hydrolysed alkyl silicate solution to form a sol, the sol is converted to a gel and the gel is sintered, wherein the dopant is a) added to the hydrolysed alkyl silicate solution, b) added in the form of fine particles, c) added to the sol, d) added to the gel or e) added during the sintering.

In principle, the processes known in the prior all follow the scheme that an alkoxide is first hydrolysed to give a silicon dioxide powder with formation of a sol which is converted to a gel, and the gel is then dried and subsequently sintered. The process comprises several stages, is laborious, is sensitive to process variations and is prone to impurities.

It was an object of the present invention to provide a process for preparing a silicon dioxide granule in which no binders are required. The process should allow the preparation of large amounts and afford products with a high purity and a low level of defects.

The invention provides a process for preparing a silicon dioxide granule having a specific surface area of less than 1 m²/g and a proportion of impurities of less than 50 ppm, in which
a) a silicon dioxide powder with a tamped density of 15 to 190 g/l,
b) is compacted to slugs which are subsequently crushed, the slug fragments having a tamped density of 210 to 800 g/l, and
c) the slug fragments are treated with one or more reactive compounds at 400 to 1100° C.

In a particular embodiment, the process can be carried out with a doped silicon dioxide powder or a silicon mixed oxide powder. Suitable dopant components or mixed oxide components are especially one or more oxides selected from the group consisting of Ag, Al, B, Ce, Cs, Er, Ga, Ge, Li, K, Na, P, Pb, Ti, Ta, Tl and Zr. More preferably, silicon dioxide powder doped with titanium dioxide, boron oxide, cerium oxide and erbium oxide may be used. The doping component or mixed oxide component may be present in and/or on the particles of the silicon dioxide powder. The silicon dioxide powder used may have one or more dopant components or mixed oxide components.

The concentration of the dopant component or mixed oxide component may be 10 ppm to 50% by weight. A dopant component will be referred to when the content is 10 ppm to 3% by weight. A mixed oxide component will be referred to when the content is >3 to 50% by weight.

Preferably, silicon-titanium mixed oxide powders which contain up to 20% by weight of titanium dioxide may be used. Particular preference may be given to a silicon-titanium mixed oxide powder which contains 3 to 8% by weight of titanium dioxide.

The silicon dioxide powders used may, for example, be those from precipitation processes, sol-gel processes or pyrogenic processes. The latter are also referred to as pyrogenic silicon dioxide powders and may be preferred.

Slugs refer to the more or less strip-like intermediates which arise in the roller compaction through the pressing of the starting material. They are crushed in a second step. The properties of the slugs and slug fragments can be influenced by the process parameters such as the selected process control mode, the compaction force, the width of the gap between the two rollers and the pressure hold time which is established through the corresponding change in the rotational speeds of the press rollers.

The silicon dioxide powder used may be one having a primary particle size of 5 to 50 nm and a BET surface area of 30 to 400 m²/g. Preferably, silicon dioxide powders having a BET surface area of 40 to 150 m²/g can be used. The purity of the silicon dioxide powder used is at least 99% by weight and preferably at least 99.9% by weight.

The silicon dioxide powder used has a tamped density of 15 to 190 g/l. Preference is given to using a silicon dioxide powder having a tamped density of 30 to 150 g/l and more preferably one of 90 to 130 g/l. The tamped densities specified in the invention are determined to DIN EN ISO 787-11. The tamped density of the silicon dioxide powder can be compacted to these values by means of known processes and apparatus. For example, the apparatus according to U.S. Pat. No. 4,325,686, U.S. Pat. No. 4,877,595, U.S. Pat. No. 3,838,785, U.S. Pat. No. 3,742,566, U.S. Pat. No. 3,762,851, U.S. Pat. No. 3,860,682 can be used. In a preferred embodiment of the invention, a silicon dioxide powder which has been compacted by means of a pressing band filter according to EP-A-0280851 or U.S. Pat. No. 4,877,595 can be used.

The silicon dioxide powder with the tamped density of 15 to 190 g/l is subsequently compacted to slugs. Compaction is understood to mean mechanical compression without addition of binder. In the compaction, homogeneous pressing of the silicon dioxide powder should be ensured in order to obtain slugs with a very substantially homogeneous density.

The compaction to slugs can be effected by means of two rollers, of which one or else both may simultaneously have a venting function.

Preferably, two compacting rolls can be used, which may be smooth or profiled. The profile may be present either only on one compacting roll or on both compacting rolls. The profile may consist of axially parallel corrugations or of any arrangement of recesses (depressions) in any configuration. In a further embodiment of the invention, at least one of the rollers may be a vacuum roller.

For the compaction, a suitable process is especially a process in which the pyrogenic silicon dioxide powder to be compacted is compacted by means of two compacting rollers, of which at least one is arranged so as to be drivable with rotation and bring about the specific pressures of 0.5 kN/cm to 50 kN/cm, the surface of the compacting rollers consisting of a material which is predominantly or completely free of metals and/or metal compounds, or the surface consists of a very hard material. Suitable materials are industrial ceramics, for example silicon carbide, silicon nitride, coated metals or aluminium oxide. The process is suitable for minimizing the contamination of the slug fragments and of the silicon dioxide granule.

After the compaction, the slugs are crushed. For this purpose, a screen granulator which, with its mesh width of the screen, defines the particle size can be used. The mesh width may be 250 μm to 20 mm.

For the crushing of the slugs, an apparatus with two contrarotatory rollers with a defined gap or a spiked roller may be used.

The slug fragments can be classified by means of a sifter, of a screen or of a classifier.

The slug fragments have a tamped density of 210 to 800 g/l. The slug fragments preferably have a tamped density of 300 to 700 μm and more preferably 400 to 600 μm. The slug fragments generally have a tamped density higher by 10 to 40% than the uncrushed slugs.

The fine fraction (particles smaller than 100 μm) can be removed. The sifters used may be crossflow sifters, countercurrent deflection sifters, etc. The classifier used may be a cyclone. The fine content removed in the classification (particle size smaller than 100 μm) can be recycled into the process according to the invention.

The classified slug fragments are subsequently exposed at temperatures of 400 to 1100° C. to an atmosphere which comprises one or more reactive compounds which are suitable for removing hydroxyl groups and impurities from the slug fractions. These may preferably be chlorine, hydrochloric acid, sulphur halides and/or sulphur oxide halides. More preferably, chlorine, hydrochloric acid, disulphur dichloride or thionyl chloride may be used.

Usually, the reactive compounds are used in combination with air, oxygen, helium, nitrogen, argon and/or carbon dioxide. The proportion of the reactive compounds may be 0.5 to 20% by volume.

Subsequently, depending on the composition of the slugs, it is also possible to sinter at 1200° C. to 1700° C.

The invention further provides a silicon dioxide granule which is obtainable by the process according to the invention.

A sintered silicon dioxide granule may especially be a silica glass granule.

The sum of the impurities in the inventive silicon dioxide granule may preferably be <50 ppm. The sum of the impurities may preferably be less than 10 ppm and more preferably less than 5 ppm. The proportion of metallic impurities may preferably be <5 ppm and more preferably <1 ppm.

Particular preference may be given to a granule which has the following contents of impurities, all in ppb: Al≦600, Ca≦300, Cr≦250, Cu≦10, Fe≦800, K≦80, Li≦10, Mg≦20, Mn≦20, Na≦80, Ni≦800, Ti≦200, V≦5 and Zr≦80. A distinction should be drawn between an impurity and a dopant component. A dopant component is a substance which has deliberately been introduced into a raw material. An impurity is a substance which was present in the feedstocks from the start and/or is introduced unintentionally during the process.

Very particular preference may be given to a granule which has the following contents of impurities, all in ppb: Al≦350, Ca≦90, Cr≦40, Cu≦3, Fe≦100, K≦50, Li≦1, Mg≦10, Mn≦5, Na≦50, Ni≦80, Ti≦100, V≦1, Zr≦3.

To determine the metal content, the silicon dioxide granule is dissolved in a hydrofluoric acid-containing solution. The silicon tetrafluoride which forms evaporates and the remaining residue is analysed by means of inductively coupled plasma mass spectrometry (ICP-MS). The precision is approx. 10%.

The invention further provides for the use of the silicon dioxide granule for producing materials with very low coefficients of expansion, for photocatalytic applications, as a superhydrophilic constituent of self-cleaning mirrors, for optical items such as lenses, as a seal for gases and liquids, as a mechanical protective layer, as a use in composite materials, as a catalyst and catalyst support.

### EXAMPLES

The examples are carried out according to the following procedure. Feedstocks, reaction conditions and apparatus settings are reproduced in Table 1.

The silicon dioxide powders used are prepared pyrogenically. The powder from Example 1 is AEROSIL® 300, from Degussa. The preparation of the powders used in Examples 2 and 3 is described in EP-A-1321444, in Example 4 in DE-A-10134382 and in Example 5 in EP-A-995718.

The resulting rod-shaped slugs are crushed by means of a comminution machine (Frewitt MG-633) equipped with a screen fabric (size 800 μm). After the fines removal, stable slug fragments are obtained. Subsequently, the slug fragments are purified in a reactor in an HCl, HCl/SOCl₂ or HCl/S₂Cl₂ gas stream and then sintered. In each case, a high-purity silicon dioxide granule is obtained with the dimensions and impurities listed in Table 1.

The inventive silicon dioxide granule is highly pure. It does not comprise a binder. The dust content is reduced significantly in comparison to the powder used.

The silicon dioxide granule has the necessary cohesion in order not to decompose again prematurely in the next steps of an application. Nevertheless, it exhibits good incorporability.

TABLE 1
Feedstocks, reaction conditions and apparatus settings

| | | Example | | | | |
|---|---|---|---|---|---|---|
| | | 1 | 2 | 3 | 4 | 5 |
| SiO₂ used | | | | | | |
| BET surface area | m²/g | 301 | 42 | 90 | 48 | 55 |
| Dopant component | | — | TiO₂ | TiO₂ | Er₂O₃ | Al₂O₃ |
| Content | % by wt. | — | 7.3 | 7.3 | 0.528 | 0.19 |
| Tamped density | g/l | 19 | 61 | 53 | 3 | 94 |

Compactor¹

| | | | | | | |
|---|---|---|---|---|---|---|
| Pressing force | kN | 20 | 50-65 | 25-30 | 65-70 | 40-45 |
| Roller speed | min | 3 | 5 | 4 | 6 | 4 |
| Screw speed | min | 30 | 25 | 28 | 35 | 22 |

Slug/Slug fragments

| | | | | | | |
|---|---|---|---|---|---|---|
| Tamped density | | | | | | |
| Slug² | g/l | 277 | 430 | 400 | 390 | 380 |
| Slug fragment³ | g/l | 302 | 610 | 540 | 530 | 500 |
| Purification | | | | | | |
| Purification gas | | HCl/ | HCl | HCl | HCl/ | HCl |
| | | SOCl₂ | | | S₂Cl₂ | |
| Temperature | ° C. | 920 | 800 | 800 | 900 | 850 |
| Time | min | 20 | 40 | 30 | 20 | 60 |

Sintered SiO₂ granule

| | | | | | | |
|---|---|---|---|---|---|---|
| Sintering temperature | ° C. | 1280 | 1250 | 1230 | 1350 | 1380 |
| BET surface area | m²/g | <1 | <1 | <1 | <1 | <1 |
| Impurities | | | | | | |
| Li | ppm | <0.01 | <0.1 | <0.1 | <0.1 | <0.1 |
| B | ppm | 0.019 | <0.1 | <0.1 | <0.1 | <0.1 |
| Na | ppm | <0.01 | <0.1 | <0.1 | <0.1 | <0.1 |
| Mg | ppm | 0.013 | <0.1 | <0.1 | <0.1 | <0.1 |
| Al | ppm | 0.060 | 0.65 | 0.82 | 0.32 | — |
| Ca | ppm | 0.030 | 0.15 | 0.2 | 0.15 | 0.34 |
| Ti | ppm | 0.026 | — | — | 0.36 | 0.45 |
| Cr | ppm | 0.036 | 0.54 | 0.43 | 0.23 | 0.35 |
| Mn | ppm | <0.01 | <0.1 | <0.1 | <0.1 | <0.1 |
| Fe | ppm | 0.031 | 0.71 | 0.68 | 0.35 | 0.65 |
| Ni | ppm | <0.01 | 0.30 | 0.41 | 0.14 | 0.26 |
| Cu | ppm | <0.01 | 0.12 | <0.1 | <0.1 | <0.1 |
| Zr | ppm | 0.036 | <0.1 | 0.16 | <0.1 | 0.25 |
| K | ppm | <0.01 | <0.1 | <0.1 | <0.1 | <0.1 |
| SiOH group density | ppm | 12 | 20 | 24 | 32 | 18 |

¹Compactor: L 200/50 P, from Hosokawa BEPEX GmbH; Working width: 50 mm; with preliminary venting; equipped with a 12 mm hardened steel roller with a waved profile, closed at the side;
²Before classification;
³After classification

1. A process for preparing a silicon dioxide granule having a specific surface area of less than 1 m²/g and a proportion of impurities of less than 50 ppm, in which
a) a silicon dioxide powder with a tamped density of 15 to 190 g/l,
b) is compacted to slugs which are subsequently crushed, the slug fragments having a tamped density of 210 to 800 g/l, and
c) the slug fragments are treated with one or more reactive compounds at 400 to 1100° C.

2. The process according to claim 1, wherein the silicon dioxide powder is a doped silicon dioxide powder or a silicon mixed oxide powder.

3. The process according to claim 2, wherein the doped silicon dioxide powder, as a dopant component, or the silicon mixed oxide powder, as a mixed oxide component, comprises an oxide selected from the group consisting of the oxides of Ag, Al, B, Ce, Cs, Er, Ga, Ge, Li, K, Na, P, Pb, Ti, Ta, Tl and Zr.

4. The process according to claim 2, wherein the silicon dioxide powder or silicon mixed oxide powder is doped with 10 ppm to 50% by weight of the dopant.

5. The process according to claim 1, wherein the silicon dioxide powder is a pyrogenic silicon dioxide powder.

6. The process according to claim 1, wherein the silicon dioxide powder has a tamped density of 30 to 150g/l.

7. The process according to claim 5, wherein the slug fragments have a tamped density of 300 to 650 g/l.

8. The process according to claim 1, wherein the slug fragments are classified.

9. The process according to claim 1, wherein the reactive compounds are used as a mixture with air, oxygen, helium, nitrogen, argon and/or carbon dioxide or oxygen.

10. The process according to claim 1, wherein the slug fragments are sintered with the reactive compound after the treatment.

11. A silicon dioxide granule obtained according to claim 1.

12. The silicon dioxide granule according to claim 11, wherein it is a silica glass granule.

13. The silicon dioxide granule according to claim 11, wherein the proportion of metallic impurities is less than 50 ppm.

14. (canceled)

15. A material having a very low coefficient of expansion comprising the silicon dioxide granule according to claim 11.

16. A method for making a photocatalyst comprising providing the silicon dioxide granule according to claim 11.

17. A superhydrophilic constituent of self-cleaning mirrors comprising the silicon dioxide granule according to claim 11.

18. A method for making an optical lens comprising providing the silicon dioxide granule according to claim 11.

19. A seal for gases and liquids comprising the silicon dioxide granule according to claim 11.

20. A mechanical protective layer comprising the silicon dioxide granule according to claim 11.

21. A method for making a composite material comprising providing the silicon dioxide granule according to claim 11.

22. A catalyst or catalyst support comprising the silicon dioxide granule according to claim 11.
